(19) United States
(12) Patent Application Publication
(10) Pub. No.: US 2004/0235334 A1
(43) Pub. Date: Nov. 25, 2004

(54) Safety outlet and plug

(76) Inventor: Koum-Hwuan Kim, Chungcheongnam-Do (KR)

Correspondence Address: LADAS & PARRY LLP, 224 SOUTH MICHIGAN AVENUE, SUITE 1200, CHICAGO, IL, 60604, US

(21) Appl. No.: 10/489,091

(22) PCT Filed: Nov. 2, 2002
(86) PCT No.: PCT/KR02/02045

(30) Foreign Application Priority Data
Nov. 12, 2001 (KR) 2001/34695

(51) Int. Cl. H01R 13/64

(52) U.S. Cl. 439/381

(57) ABSTRACT

The present invention relates to an outlet and plug which are coupled with each other to supply electricity to household electric appliances and to a safety outlet and plug which can be safely used by preventing an electric shock and a short circuit occurring when conductive objects are inserted into the outlet. A prong slot of the outlet is formed in a curved shape and a grasper is installed in an inner side of the prong slot. A prong of the plug is also formed in a curved shape such that the prong of the plug is inserted into the prong slot of the outlet. A conductive projection formed on an end of the prong is connected with the grasper of the outlet to thereby supply electricity. Due to the curved shape of the prong slot, a long conductor does not pass through the prong slot, so that an electric shock and a short circuit can be prevented.

### TECHNICAL FIELD

The present invention relates to an outlet and plug which are coupled with each other to supply electricity to household electric appliances, and more particularly, to a safety outlet and plug which can be safely used by preventing an electric shock and a short circuit occurring when conductive objects are inserted into the outlet.

### BACKGROUND ART

In case of using electricity by inserting a plug into an outlet, an electric current still flows in an inside of the outlet even when the plug is disengaged from the outlet. Therefore, if conductive objects (e.g., chopsticks, nails, pins, etc.) are inserted into slots of the outlet by accident or out of children's mischief, electrical accident may be caused due to an electric shock and a short circuit (nowadays is more dangerous since boosted power of 220 V is transmitted). Thus, people feel uneasy when using the outlet at places where children are playing or at general home.

### DISCLOSURE OF THE INVENTION

In a conventional outlet, since a prong slot is formed in a straight shape, long metal things may be inserted into the prong slot, which causes a problem of an electric shock and a short circuit. In order to solve the problem, a prong slot of an outlet in accordance with the present invention is formed in a curved shape. Also, a prong of a plug is formed in a curved shape, such that long conductors are not put in the prong slot of the outlet.

According to the present invention, a prong slot of the outlet is formed in a curved shape and a grasper is installed in an inner side of the prong slot. A prong of the plug is also formed in a curved shape such that the prong of the plug is inserted into the prong slot of the outlet. A conductive projection formed on an end of the prong is connected with the grasper of the outlet to thereby supply electricity. Due to the curved shape of the prong slot, a long conductor does not pass through the prong slot, so that an electric shock and a short circuit can be prevented.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a perspective view of a plug and an outlet in accordance with an embodiment of the present invention;

FIG. 2 is a sectional view of a progress status when the plug is being inserted into the outlet;

FIG. 3 is a sectional view of a final status when the plug is completely inserted into the outlet;

FIG. 4 is a sectional view of a status when the prongs are inserted into the prong slots;

FIG. 5 is a partial sectional view of the prong slot;

FIG. 6 is a section view taken along the line A-A′ of FIG. 5;

FIG. 7 is a top view of the plug in accordance with an embodiment of the present invention;

FIG. 8 is a sectional view of a rotary outlet in accordance with the present invention;

FIG. 9 is a sectional view of a normal adaptor in accordance with the present invention; and

FIG. 10 is a sectional view of a reverse adaptor in accordance with the present invention.

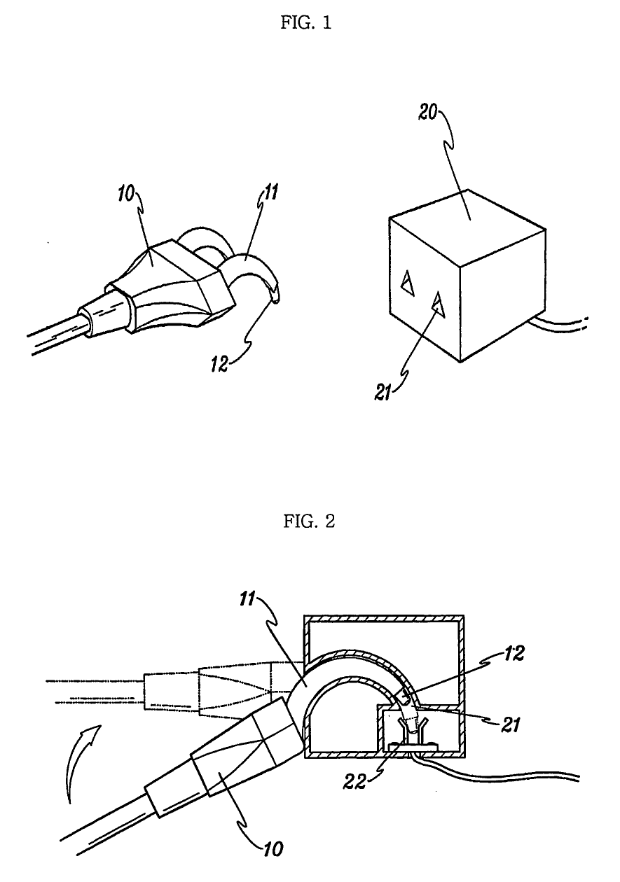

### BEST MODE FOR CARRYING OUT THE INVENTION

Hereinafter, preferred embodiments of the present invention will be described in detail with reference to the attached drawings.

According to the present invention, prongs 11 of a plug 10 are formed in a curved shape and conductive projections 12 are formed on ends of the curved prongs 11. Prong slots 21 of an outlet 20 are formed in a curved shape so that the curved prongs 11 can be inserted thereinto. Additionally, a grasper 22 is installed inside the outlet such that the curved prongs 11 are coupled therewith. The curved prongs 11 of the plug 10 are inserted into the outlet 20 along the curved prong slots 21 and the conductive projections 12 are fitted into the grasper 22, thereby supplying electricity. At this time, a curvature of the curved prongs 11 is the same as that of the prong slots 21. Also, the curved prongs 11 have a semicircular-like shape when horizontally placed. After the plug is stood almost upright, the curved prongs 11 are inserted into the prong slots 21 until the plug 10 are placed horizontally, such that the conductive projections 12 are fitted into the grasper 22.

A plurality of hanging jaws 23 are formed inside the prong slots 21 in an arc shape. The hanging jaws 23 are connected to a connection groove 24, and projections are formed from an outer side to an inner side such that objects (e.g., conductors) are prevented from being inserted from an exterior. The hanging jaws 23 are formed at the curved portions of the prong slots 21.

Since each sectional surface of both the prong slots 21 and the curved prongs 11 is a triangular shape, the inserting direction can be ensured.

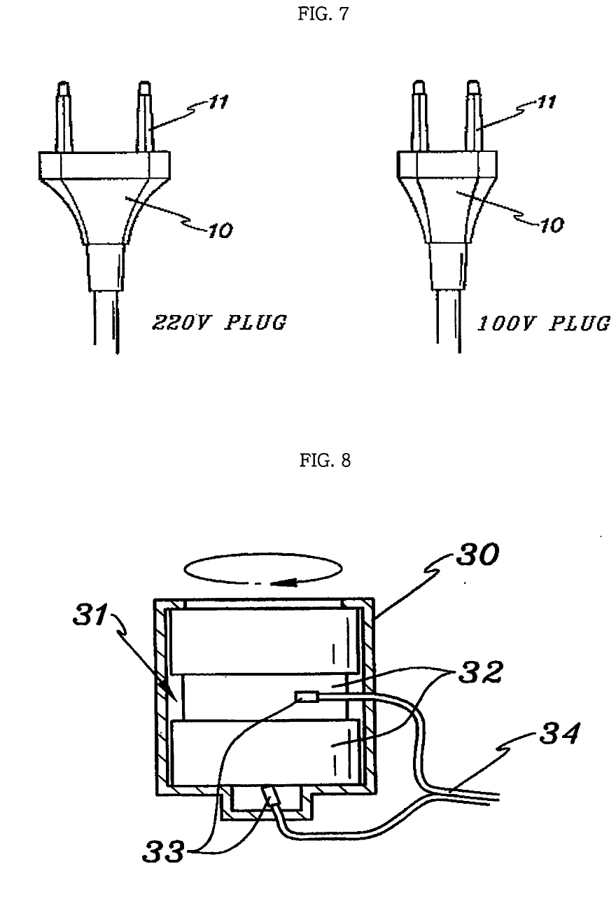

As shown in FIG. 7, the plug 10 of the present invention can be classified into 100V plug and 220V plug according to length of the curved prongs 11. In other words, the 100V plug has a length shorter than the 200V plug.

Meanwhile, FIG. 8 is a view of a rotary outlet 30 in accordance with an embodiment of the present invention. Referring to FIG. 8, a rotating body 31 is installed rotatably and supplied with electricity through a copper plate 32. The copper plate 32 can allow electricity flowing through an electric wire to be supplied through rotating contact terminals 33.

The rotating body 31 rotates left and right and can be supplied with electricity under rotation through the rotating contact terminals 33. The plug 10 inserted into the rotary outlet 30 can be rotated in that state.

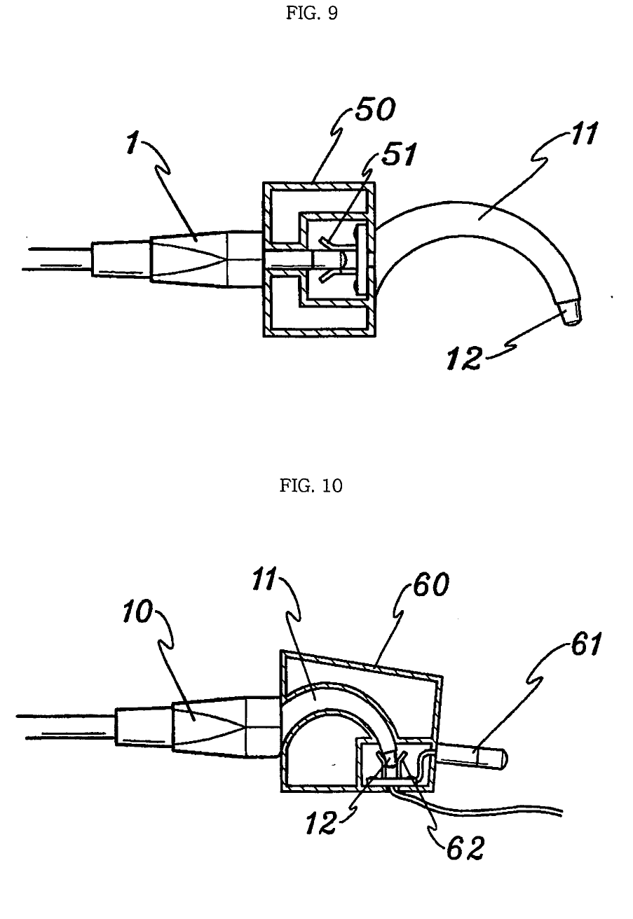

As shown in FIGS. 9 and 10, an existing plug 1 can be also used by inserting it into a normal adaptor 50 or a reverse adaptor 60. The plug of the present invention can be used in an existing outlet.

Prongs 2 of the existing plug 1 are inserted into the normal adaptor 50 and connected with the grasper 51. The normal adaptor 50 includes curved prongs 11 having conductive projections 12 electrically connected with the grasper 51. The reverse adaptor 60 includes an existing prongs 61 formed on a rear side and the prongs 61 are electrically connected with the grasper 62.

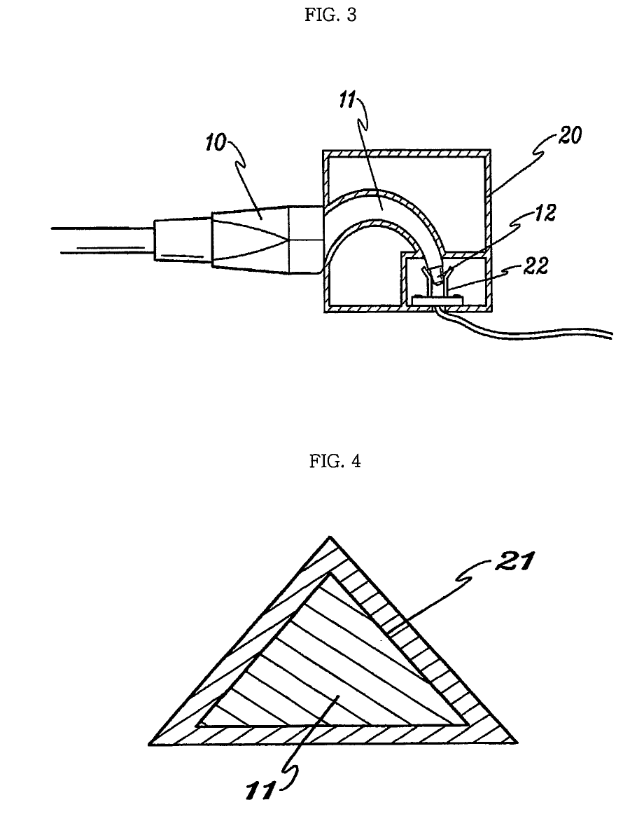

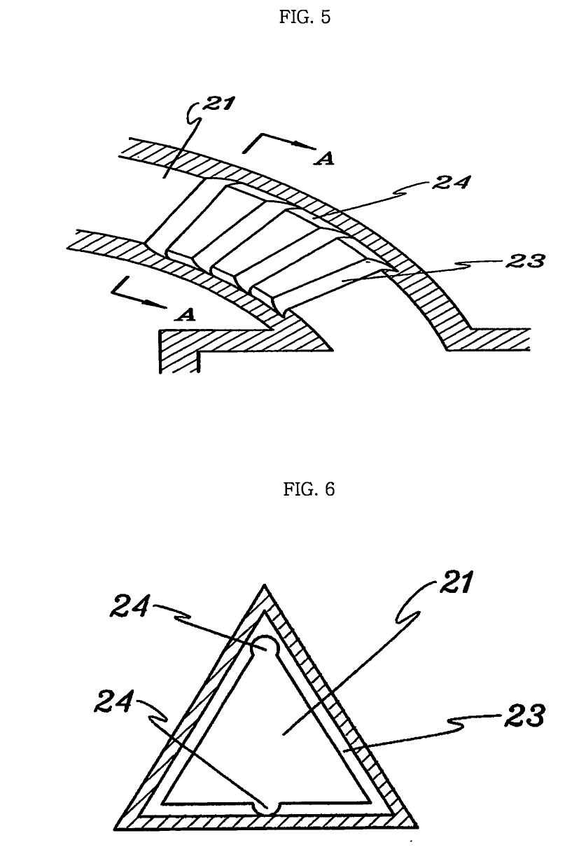

When the plug 10 is inserted into the outlet 20 as shown in FIG. 2, the curved prongs 11 are inserted into the prong slots 21 in a state that the plug is stood almost upright, such that the curved prongs 11 are inserted into the outlet 20 along the curved portions of the prong slots 21. By completely inserting the curved prongs 11, the conductive projections 12 are electrically connected with the grasper 22, as shown in FIG. 3.

The prongs 11 and the prong slots 21 are formed in a triangular shape, so that they can be inserted in a predetermined direction. Therefore, the curved prongs 11 can be prevented from being inserted in an upset state.

Meanwhile, in case of pulling out the plug 10, the curved prongs 11 are pulled out from the prong slots 21 while pressing the plug 10 downwardly.

When the curved prongs 11 of the plug 10 are completely inserted into the prong slots 21, the conductive projections 12 are fitted into the grasper 22, such that the electricity is supplied from the outlet 20 to the plug 10.

At this time, the projection 12 is formed of conductive material, and the remaining portion of the curved prong 11 is covered with insulating material, thereby preventing an occurrence of electrical accidents.

Meanwhile, if a long conductive stick is inserted into the prong slots 21 of the outlet 20 in a state that the plug 10 is not inserted, the long conductive stick does not pass through the curved prong slots 21. Accordingly, electricity does not flow through the conductive stick and thus an electrical shock or a short circuit can be prevented.

In case of an elastic conductor, the elastic conductor may be inserted into the prong slots 21 of the outlet 20. However, since the outlet of the present invention includes the hanging jaws 23 in which the projection is formed on the curved portion, the elastic conductor is not put in the prong slots 21 due to the projection of the hanging jaws 23.

Since any kinds of conductors cannot be pushed in the prong slots 21, an electric shock or a short circuit is prevented.

Meanwhile, since the rotary outlet 30 constructed as shown in FIG. 8 is freely rotatable in a state that the plug 10 is inserted, electricity can be supplied through the rotating contact terminals 33 without regard to the rotation of the plug 10.

According to the present invention, the existing plug 1 can be inserted into the outlet 20 using the normal adaptor 50. If the prongs 11 of the existing plug 1 are inserted into the normal adaptor 50, the prongs 11 of the existing plug 1 are connected with the grasper 51 to thereby form an electric path, and the prongs 11 electrically connected with the grasper 51 are formed on one side of the normal adaptor 50.

Accordingly, the present invention can solve a problem that the existing plug 1 is not inserted into the outlet 20, and thus the existing plug 1 can be freely inserted into the outlet 20 using the normal adaptor 50.

Additionally, the plug 10 of the present invention can be used in the existing outlet by inserting the plug 10 into the reverse adaptor 60. The prongs 11 of the plug 10 are inserted into the reverse adaptor 60 and electrically connected with the grasper 62. The grasper 62 is electrically connected with the prongs 61 of the existing plug and the prongs 61 are inserted into the existing plug.

Although not shown in the drawings, the prongs 11 of the plug 10 can be easily inserted into the outlet 10 by forming the prongs of soft and elastic materials. Meanwhile, the prongs can be straightly inserted into the existing outlet by forming about 2 cm of the prong from an end portion of the prong 11 thicker than an entire thickness thereof.

Although the preferred embodiments of the present invention have been disclosed for illustrative purpose, those skilled in the art will appreciate that various modifications, additions and substitutions can be made without departing from the scope and spirit of the invention as defined in the accompanying claims.

### INDUSTRIAL APPLICABILITY

According to the present invention, since prong slots into which prongs of a plug is inserted are formed in a curved shape, conductors cannot be put in the prong slots of the outlet, thereby preventing dangerous factors such as an electric shock and a short circuit.

Additionally, without regard to hard conductors or elastic and flexible conductors, any kinds of conductors cannot be put in the prong slots of the outlet, thereby preventing dangers such as a short circuit or an electric shock due to children's mischief.

1. A safety outlet and plug in which a prong of the plug is inserted into a prong slot of the outlet, wherein prong 11 of the plug 10 is formed in a curved shape and a conductive projection is formed on an end of the prong 11, and
a prong slot 21 of the outlet is formed in a curved shape so that the prong 11 is inserted thereinto, and a grasper 22 with which the conductive projection 12 is connected is installed inside the prong slot 21, and
the prong 11 of the plug 10 is inserted into the outlet 20 along the curved portion of the prong slot 21 and the conductive projection 12 is electrically connected with the grasper 22.

2. The safety outlet and plug as claimed in claim 1, wherein the prong 11 of the plug 10 and the prong slot 21 of the outlet 20 are formed in a curved shape, sectional surfaces of the prong 11 and the prong slot 21 being triangular shape.

3. The safety outlet and plug as claimed in claim 1, further comprising a plurality of hanging jaws 23 formed on the curved portion of the prong slot 21 in a circumference direction, the hanging jaws 23 being connected through a connection groove 24.
